(19) United States
(12) Patent Application Publication
(10) Pub. No.: US 2019/0219129 A1
(43) Pub. Date: Jul. 18, 2019

(54) Connecting Assembly For Connecting A Plurality Of Damper Mass Elements Of A Damper Mass

(71) Applicant: ZF FRIEDRICHSHAFEN AG, Friedrichshafen (DE)

(72) Inventors: Christoph FAUSS, Werneck (DE); Achim KRAUS, Lohr am Main (DE); Bernhard SCHIERLING, Kürnach (DE); Nikolaj KNAUS, Schweinfurt (DE)

(21) Appl. No.: 16/303,002

(22) PCT Filed: Apr. 18, 2017
(86) PCT No.: PCT/EP2017/059083

§ 371 Date: Nov. 19, 2018

(30) Foreign Application Priority Data
May 19, 2016 (DE) 10 2016 208 636.7

(51) Int. Cl. F16F 15/14

(52) U.S. Cl. CPC F16F 15/145; F16F 2230/0041

(57) ABSTRACT

A connection arrangement serves to connect a plurality of damper mass elements by connection elements in order to form a damper mass. The connection elements have in each instance a central axis in axial direction and are formed in each instance by a shaft with shaft ends at both sides, and the shaft ends and the shaft are enclosed in each instance by inner walls of passages of the damper mass elements, which inner walls extend around the central axis. At least a portion of the shaft ends has, by a hole face, a connection to the respective associated inner wall of the corresponding passage of the respective damper mass element.

### CROSS REFERENCE TO RELATED APPLICATIONS

This is a U.S. national stage of application No. PCT/EP2017/059083, filed on Apr. 18, 2017. Priority is claimed on German Application No. DE102016208636.7, filed May 19, 2016, the content of which is incorporated here by reference.

### BACKGROUND OF THE INVENTION

### 1. Field of the Invention

The invention is directed to a connection arrangement for the connection of a plurality of damper mass elements by connection elements to form a damper mass, wherein the connection elements each have a central axis in axial direction and are formed by a shaft with shaft ends at both sides, the shaft ends and the shaft are enclosed by inner walls of passages of the damper mass elements that inner walls extend around the central axis.

### 2. Description of the Prior Art

A connection arrangement 101 of the type mentioned above is illustrated in FIGS. 1 to 3 which show the prior art. FIG. 1 or FIG. 2 shows a damper system 102 with a damper mass carrier 103 formed as a hub disk that has guideways 111 (FIG. 1) in which coupling elements 115 are received so as to be relatively movable. The coupling elements 115 further run in guideways 117 of damper masses 118, which in each instance comprise a plurality of damper mass elements 119a to 119c. The axially outer damper mass elements 119a and 119c of the above-mentioned damper mass elements 119a to 119c are arranged axially at both sides of the damper mass carrier 103, and damper mass elements 119b are received axially therebetween. Due to the fact that damper mass elements 119a and 119c extend farther radially inward than damper mass elements 119b, damper mass elements 119a and 119c form a receiving space 105 axially therebetween for stop elements 107 which are fastened to the damper mass carrier 103 and which are operative in circumferential direction and in radial direction and limit a relative movement of the damper masses 118 with respect to the damper mass carrier 103. Damper mass elements 119a and 119c also limit the axial relative movability of the damper masses 118 with respect to the damper mass carrier 103 because they extend farther radially inward than damper mass elements 119b.

As is shown in FIG. 3 as an enlarged view of detail Z depicted in FIG. 2, the damper mass elements 119a to 119c have passages 124a to 124c, which are aligned with one another along central axes 121. Passage 124a is formed in damper mass element 119a, passages 124b are formed in damper mass elements 119b, and passage 124c is formed in damper mass element 119c. Passages 124a to 124c surround the connection elements 120 with inner walls 128a to 128c. Passage 124a encloses a shaft end 130 of the respective connection element 120, passages 124b enclose a shaft 132, and passage 124c encloses a shaft end 134. Passage 124a leads into a widening 138a at the axial outer side of damper mass element 119a, and passage 124c leads into a widening 138b at the axial outer side of damper mass element 119a. When carrying out a riveting process, the shaft end 130 is deformed accompanied by the formation of a head 139a in widening 138a, and shaft end 134 is deformed accompanied by the formation of a head 139b in widening 138b. Damper mass elements 119a to 119c are then connected, respectively, to form a damper mass 118, specifically in such a way that the connection elements 120 do not extend axially beyond the axially outer damper mass elements 119a or 119c. This allows for an axially compact construction of the damper masses 118.

Inasmuch as a cost-optimized production is desirable, damper mass elements 119a to 119c are usually formed by stamping, and widenings 138a and 138b are formed by punching. A plurality of work steps are required for this purpose. If punching is dispensed with in order to further optimize costs, then only a stamping process would be required to produce the damper mass elements. This would make it possible to use tools with fewer tool steps and to press with less press force, but the heads 139a, 139b of the connection elements 120 would then extend axially beyond the axially outer damper mass elements 119a or 119c such that the damper masses 118 would require more axial installation space, the availability of which is usually extremely limited.

### SUMMARY OF THE INVENTION

It is an object of one aspect of the invention to develop a connection arrangement serving to connect a plurality of damper mass elements for forming damper masses that allows an arrangement of the damper masses in limited installation space with an extremely cost-optimized production.

A connection arrangement is disclosed for the connection of a plurality of damper mass elements by connection elements to form a damper mass. The connection elements have a central axis in axial direction and are formed by a shaft with shaft ends at both sides, the shaft ends and the shaft are enclosed, respectively, by inner walls of passages of the damper mass elements that inner walls extend around the central axis.

In particular, it is provided that at least a portion of the shaft ends has, by a hole face, a connection to the respective associated inner wall of the corresponding passage of the respective damper mass element.

Using this procedure, a deformation is achieved in the areas of the shaft ends of the respective connection element, by which a sufficient widening of the shaft end with respect to the inner wall of the passage of the respective damper mass element can be brought about in order to achieve a hole face in this passage, and, therefore, to produce a frictionally engaging connection between the respective shaft end and the passage of the corresponding damper mass element. In this respect, it is key that a stamp of the respective tool acts in the center of the connection element, i.e., in the immediate area around its central axis. In this way, a hole face is generated without substantial deformation of the shaft ends of the respective connection element. In order to produce the hole face, the shaft ends of the connection elements are impacted by a stamp of a tool at axial end faces so that material is displaced from the center of the respective shaft end into the circumferential area of the shaft end. This process can be carried out with comparatively little force amounting to only a fraction of the force required in the prior art to produce impressions.

The connection elements are preferably formed in each instance by a pin, the cross section of which is at least substantially constant along its axial extension.

### BRIEF DESCRIPTION OF THE DRAWINGS

The invention is described in the following referring to an embodiment example. The drawings show:

FIG. 1 is a top view of a prior-art damper system with a damper mass carrier and with a plurality of damper masses which are relatively movably received at the damper mass carrier;

FIG. 2 is a sectional view of the damper system according to line B-B in FIG. 1 with damper masses having a plurality of damper mass elements, wherein the damper mass elements are connected to one another by a connection arrangement formed by connection elements;

FIG. 3 is an enlarged view of detail Z, shown in FIG. 2, for illustrating the connection elements of the connection arrangement;

FIG. 4 is a damper system with a solution according to one aspect of the invention;

FIG. 5 is a sectional view of the damper system according to line B-B in FIG. 4 with damper masses having a plurality of damper mass elements, wherein the damper mass elements are connected to one another by a connection arrangement formed by connection elements;

FIG. 6 is an enlarged view of detail Z, shown in FIG. 5, for illustrating the connection elements of the connection arrangement.

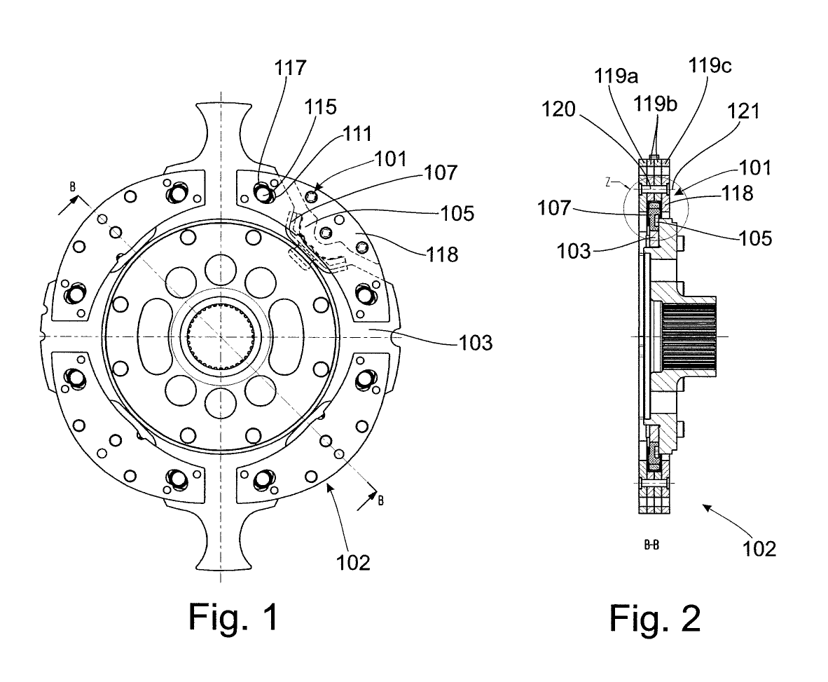

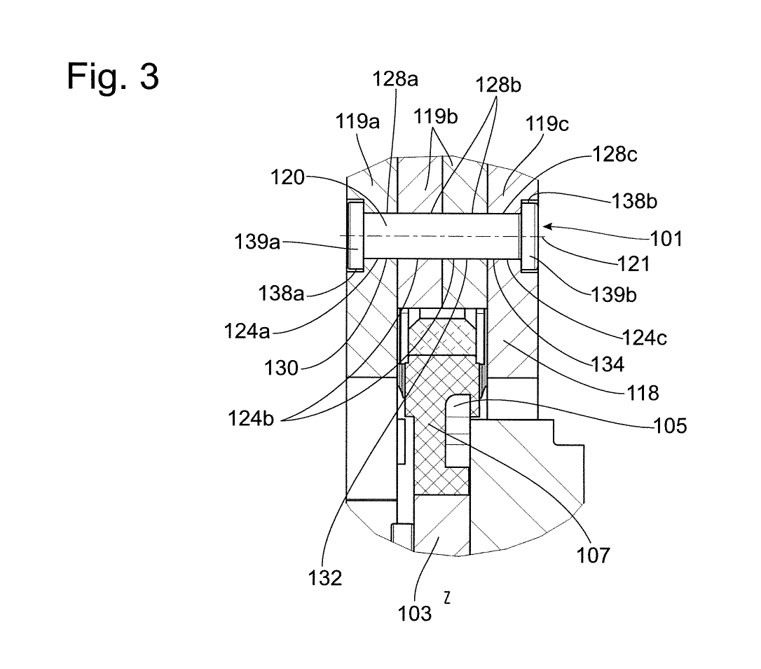

### DETAILED DESCRIPTION OF THE PRESENTLY PREFERRED EMBODIMENTS

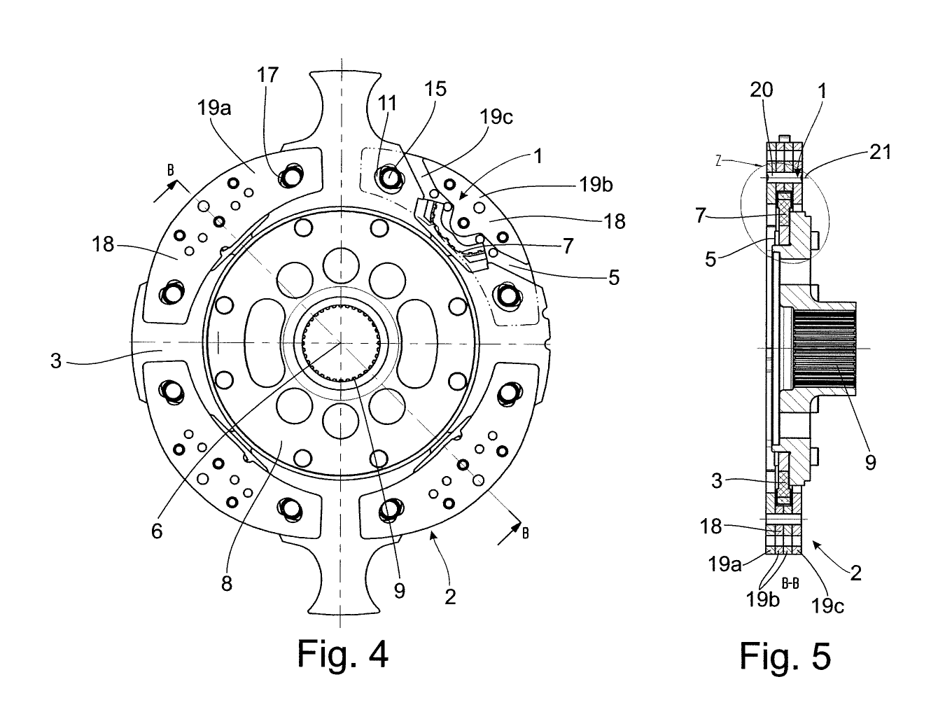

A damper system 2 having a connection arrangement 1 is shown in FIGS. 4 to 6. The damper system 2, which is rotatable around a central axis 6, is provided with a damper mass carrier 3 formed as a hub disk and connected to a hub 8 provided with an inner toothing 9 for connecting to a shaft, not shown, for example, a transmission input shaft, so as to be fixed with respect to rotation relative to it. The damper mass carrier 3 has guideways 11 (FIG. 4) in which coupling elements 15 are relatively movably received. The coupling elements 15 further run in guideways 17 of damper masses 18 that each comprise a plurality of damper mass elements 19a to 19c. The axially outer damper mass elements 19a and 19c of these damper mass elements 19a to 19c are arranged axially at both sides of the damper mass carrier 3, and damper mass elements 19b are received axially therebetween. Due to the fact that damper mass elements 19a and 19c extend farther radially inward than damper mass elements 19b, damper mass elements 19a and 19c form a receiving space 5 axially therebetween for stop elements 7 fastened to the damper mass carrier 3 and which are operative in circumferential direction as well as in radial direction and limit a relative movement of the damper masses 18 with respect to the damper mass carrier 3. Damper mass elements 19a and 19c also limit the axial relative movability of the damper masses 18 with respect to the damper mass carrier 3 because they extend farther radially inward than damper mass elements 19b.

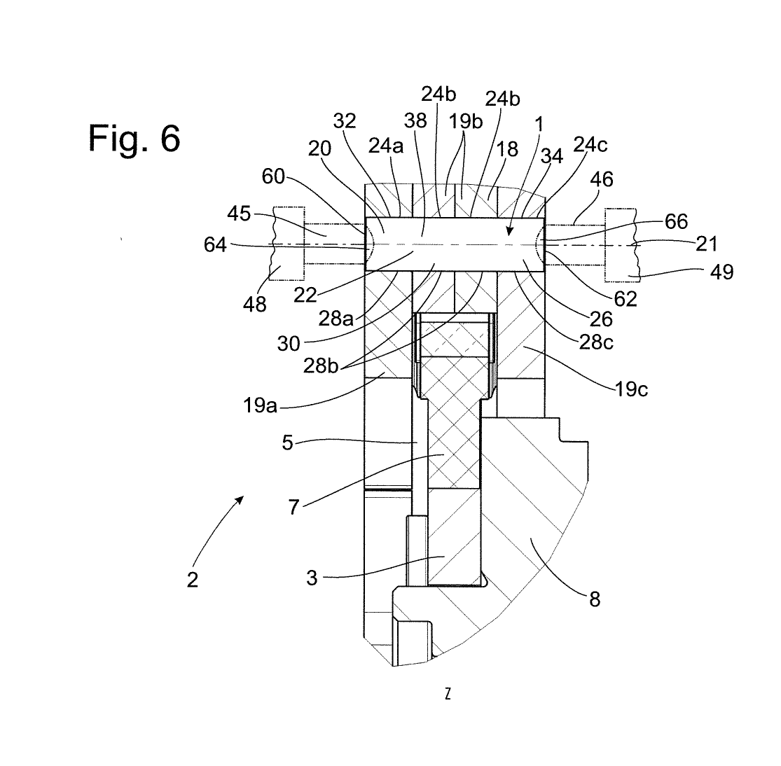

As is shown in FIG. 6 as an enlarged view of detail Z depicted in FIG. 5, the damper mass elements 19a to 19c have passages 24a to 24c that are aligned with one another along central axes 21, passage 24a being formed in damper mass element 19a, passages 24b being formed in damper mass elements 19b and passage 24c being formed in damper mass element 19c. Passages 24a to 24c surround the connection elements 20 with inner walls 28a to 28c. Passage 24a encloses a shaft end 22 of the respective connection element 20, passages 24b enclose a shaft 30, and passage 24c encloses a shaft end 26. Passages 24a have at least substantially the same inner diameter, and connection elements 20 also always have the same outer diameter at least substantially along their axial extension.

It can be seen clearly from FIG. 6 that connection elements 20 have recesses 64, 66 at axial end faces 60, 62. Recess 64 is associated with end face 60 of shaft end 22, and recess 66 is associated with end face 62 of shaft end 26. The recesses 64, 66 have areas of the end faces 60, 62 which are acted upon by stamps 45, 46 of tools 48, 49 over the course of the manufacturing process. The tools 48, 49 with stamps 45, 46 are shown only schematically in FIG. 6 by dashed lines. Through introduction of a compressive force by the stamps 45, 46 of the tools 48, 49 on the end faces 60, 62 of the shaft ends 22, 26, a material flow is initiated at the shaft ends 22, 26, specifically from the respective end face 60, 62 toward the material area at the outer diameter associated with the shaft ends 22, 26, such that a hole face 32, 34 is formed between these outer diameters and the respectively associated inner diameters of the inner walls 28a to 28c of passages 24a and 24c in the damper mass elements 19a and 19c. This hole face 32, 34 provides for a frictionally engaging connection between the shaft ends 22, 26 of the connection elements 20 and passages 24a and 24c in the damper mass elements 19a and 19c. Since the two axially outer damper mass elements 19a and 19c are secured axially relative to one another in this way, the axially inner damper mass elements 19b are also axially secured between the axially outer damper mass elements 19a and 19c. A composite is formed from the individual damper mass elements 19a to 19c, and a damper mass 18 is formed accordingly.

Since the shaft ends 22, 26 do not project axially over the respectively associated axially outer damper mass element 19a, 19c after this production process, no additional axial installation space is needed for the connection elements 20 of the connection arrangement 1. Additionally, a stamping process with only one stamping stroke is sufficient prior to this production process for producing not only the individual damper mass elements 19a to 19c but also the passages 24a to 24c in the respective damper mass elements. In addition to this, small presses with relatively slight pressing force and with a small installation space requirement for the tool in the press are sufficient for a simple stamping process of this kind. This results in low hourly operating rates, especially as maintenance costs are limited.

As regards the connection elements 20, they are preferably formed in each instance by a pin 38 with a cross section that is at least substantially constant along the axial extension of the pin 38.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-3. (canceled)

4. A connection arrangement configured to connect a plurality of damper mass elements by connection elements to form a damper mass, the connection elements each comprise:
a central axis in axial direction formed by a shaft with shaft ends at both sides, the shaft ends and the shaft are enclosed by inner walls of passages of the plurality of damper mass elements, the inner walls extend around the central axis; and
at least a portion of the shaft ends has, by a hole face, a connection to a respective associated inner wall of a corresponding passage of the respective damper mass element.

5. The connection arrangement according to claim 4, wherein the hole face is produced by a stamp of a tool that axially loads a corresponding shaft end of the respective connection element, a displacement of material is carried out by the stamp at an axial end face of the respective shaft end out of this axial end face into a material area at an outer diameter associated with the shaft end, which initiates a radial widening of the shaft end relative to an inner wall of the respective passage.

6. The connection arrangement according to claim 4, wherein the connection elements are formed by a pin, a cross section of which is at least substantially constant along its axial extension.
